(19) United States
(12) Patent Application Publication
(10) Pub. No.: US 2006/0192765 A1
(43) Pub. Date: Aug. 31, 2006

(54) Chinese character auxiliary input method and device

(75) Inventors: Ming-Hui Lin, Taipei (TW); Yu-Ling Juan, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/067,541

(22) Filed: Feb. 25, 2005

(51) Int. Cl. G09G 5/00

(52) U.S. Cl. 345/171

(57) ABSTRACT

A Chinese character auxiliary input method and device applicable to Chinese input operation of electronic equipment is proposed. When a Chinese character is inputted by a user, an auxiliary input module serves to recognize the content of the Chinese character outputted on a display installed in the electronic equipment. Subsequently, light emission of a key marked with characters that may possibly follow the previously outputted Chinese character to form a pronunciation of a word is activated according to the recognized outputted content. Thus, the user is able to rapidly select a desired key to input a plurality of Chinese character combinations, so as to output a Chinese word on the display. Therefore, the present invention is capable of shortening time consumed for searching positions of keys and improving user's input speed of Chinese characters.

### FIELD OF THE INVENTION

The present invention relates to character auxiliary input methods and devices, and more particularly, to a Chinese character auxiliary input method and device capable of determining possible characters for subsequent input, and illuminating keys of those characters by actuating the corresponding luminescent elements, such that positions of the keys can be indicated to aid a user in selecting subsequent key.

### BACKGROUND OF THE INVENTION

In recent years, along with the privatization of telecommunication enterprises and the blooming development of communication technology, the commonly used communication method has changed from conventional mails to e-mails and cellular phones. Specifically, the development of the cellular phone has been most dramatic, and as the cellular phone has the advantage of portability, the market demands continue to grow.

According to the great increase in usage of the cellular phones over the last few years in the Mandarin-speaking areas, it is obvious that its market potential is climbing. Conventional cellular phones only allowed speech communication. Nowadays, cellular phones commonly provide functions of sending and receiving messages (short messages) and e-mails. Twelve keys marked with the Chinese phonetic alphabets are provided on a control panel installed in the cellular phone, such that the user can input a text message using these keys. Therefore, the user is able to communicate with others via text. Furthermore, due to the miniaturization and portability of the cellular phone, it has become a significant communication tool in one's daily life.

People often communicate with each other by sending and receiving messages through cellular phone. However, many have experienced difficulties in finding the positions of the keys marked with Chinese characters (such as phonetic alphabets) while inputting Chinese texts. It generally takes three to six seconds for a user to search the right positions of the keys marked with the phonetic alphabet for inputting just one Chinese character. Such drawback slows down the input speed of the user.

The problem to be solved here, therefore, is how to provide a Chinese character auxiliary input method and device capable of improving the speed and efficiency for inputting the Chinese characters while reducing time consumption required for searching the positions of the keys, so as to improve the practical function of the cellular phone.

### SUMMARY OF THE INVENTION

In light of the above drawbacks in the prior art, a primary objective of the present invention is to provide a Chinese character auxiliary input method and device which is capable of indicating positions of keys marked with candidate characters that may follow a previously inputted character input (wherein “candidate characters” refers to characters which may possibly combined with the previously inputted character(s) to create a pronunciation of Chinese word) by a light source positioning method, such that a user is able to rapidly recognize and select a key required to be inputted, and thus input speed and efficiency of Chinese characters can be improved.

In accordance with the above and other objectives, the present invention proposes a Chinese character auxiliary input method and device which is used in coordination with a control panel provided in an electronic equipment, the method comprising steps of: (1) immediately actuating operation of the auxiliary input device when Chinese characters are inputted via the control panel by a user; (2) recognizing an initial character selected by the user using the auxiliary input device; and (3) outputting at least a control signal by the auxiliary input device according to the foregoing recognized initial character to activate light emission of at least a key marked with a second candidate character subsequent to the initial character, such that the user is able to rapidly select the second character required to be inputted and output such character on a display of the electronic equipment.

The auxiliary input device proposed in the present invention comprises a recognition module, a control module and a plurality of luminescent elements, wherein the number of luminescent elements corresponds to the number of keys. The recognition module serves to recognize a character inputted via the control panel and selected on the display by the user. Thus, a control signal is generated to actuate the control module to further activate light emission of at least one key marked with a second candidate character to follow the already inputted character, such that the user is able to rapidly search a desired Chinese character to be inputted among the key(s) highlighted by the light source. Therefore, the input speed and efficiency of the Chinese character can be improved while reducing time consumption required for searching the position of the key.

Accordingly, the auxiliary input device illuminates the keys located above the luminescent elements by generating upward-emitting light from the luminescent elements, such that the user is able to rapidly recognize the position of a key to be selected to therefore reduce time consumption required for searching the position of the key.

Therefore, in comparison to the techniques presented in the prior art, the Chinese character auxiliary input method and device proposed in the present invention is capable of eliminating conventional drawbacks, in specific, reducing time consumption required for searching the position of the key by the user whose Chinese input speed can hence be improved.

### BRIEF DESCRIPTION OF THE DRAWINGS

The present invention can be more fully understood by reading the following detailed description of the preferred embodiments, with reference made to the accompanying drawings, wherein:

FIG. 1 is a flowchart showing operation of an auxiliary input method according to the present invention;

FIG. 2 is a block diagram showing functional block diagram of an auxiliary input device according to the present invention;

FIG. 3 is a schematic diagram showing an appearance of a cellular phone which employs the present invention; and

FIG. 4A to FIG. 4E are diagrams showing steps of inputting a Chinese word [symbol] to be displayed using an auxiliary input method according to the present invention.

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments. In the following embodiments, a Chinese character auxiliary input method and device proposed in the present invention is applicable to a cellular phone for improving operation efficiency when user inputs Chinese characters via a control panel of the cellular phone. Further, in the following embodiments, a phonetic alphabet input method is employed for illustrating the Chinese character input method. However, what needs to be concerned here is that the application of the present invention is not limited to the cellular phone, and thus the present invention is also applicable to any electronic equipments having a Chinese character input interface, such as a desktop computer, a notebook computer, an electronic translator and a personal digital assistance. Furthermore, apart from the phonetic alphabet input method, the Chinese character can also be inputted using a Pinyin input method or a Chinese character stroke input method in the present invention. Therefore, the details may be modified based on different views and applications without departing from the spirit of the invention.

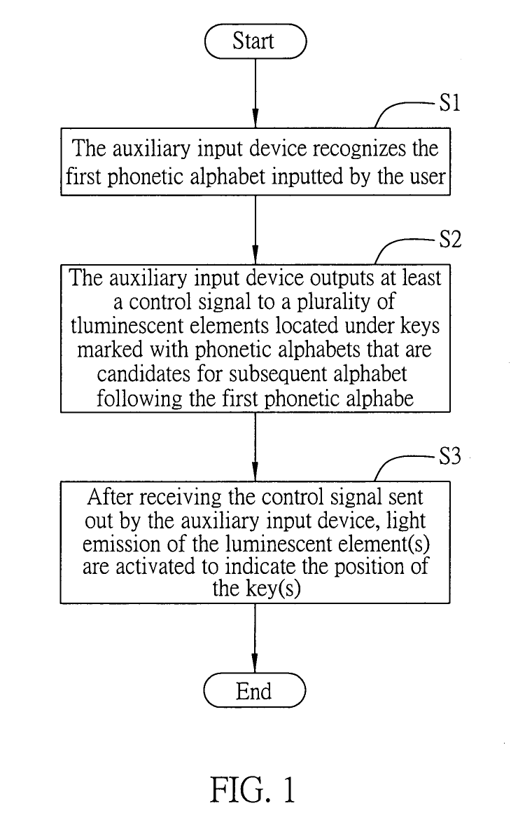

FIG. 1 is a flowchart showing operation of an auxiliary input method a user according to the present invention. Referring to the figure, first of all, after inputs a Chinese phonetic alphabet via a control panel, the auxiliary input device serves to recognize the phonetic alphabet (referred to as “first character” hereinafter) inputted by the user, such that at least one next possible phonetic alphabet can be determined. Subsequently, Step S2 is performed.

In Step S2, according to the recognized initial character, the auxiliary input device serves to output at least a control signal to a plurality of luminescent elements provided beneath a plurality of keys marked with possible phonetic alphabets. Then, Step S3 is performed.

In Step S3, the luminescent element serves to immediately emit light after receiving the control signal sent out by the auxiliary input device, so as to highlight the position of the key. Thus, keys on the control panel that corresponds to the contents shown on the display are highlighted, so that the user is able to rapidly select a phonetic alphabet to be inputted and output such phonetic alphabet on the display of the cellular phone using the illuminated key. In other words, the present invention allows the user to rapidly recognize and select the required phonetic alphabet, thereby improving user's input efficiency of Chinese characters and reducing time consumption required for searching the position of the key marked with the phonetic alphabet to be inputted.

Accordingly, in the Chinese character auxiliary input method and device, once input of a Chinese character has started; the foregoing steps S1 to S3 can be repeated until the input of a single Chinese word (or words for making up a sentence) has been completed.

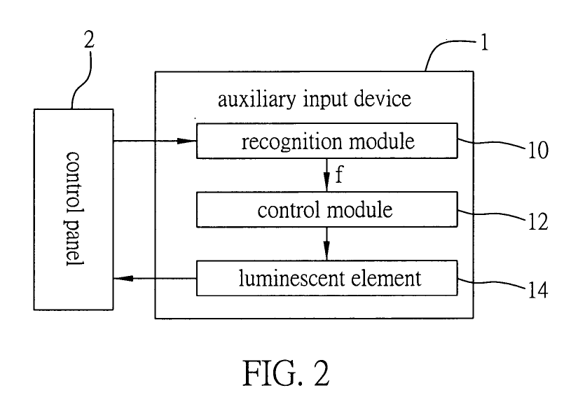

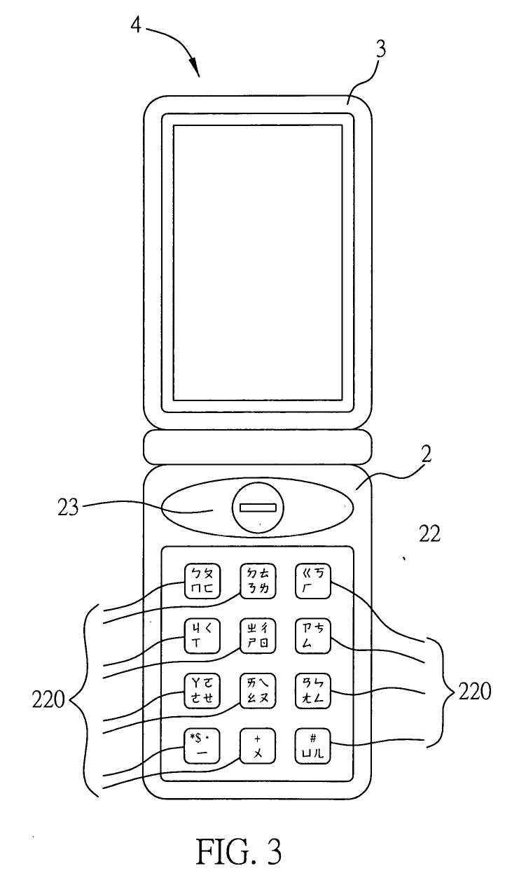

FIG. 2 is a block diagram showing functional block diagram of an auxiliary input device according to the present invention. Referring to the figure, an auxiliary input device 1 is electrically connected to a control panel 2 (also shown in FIG. 3), wherein the auxiliary input device 1 comprises a recognition module 10, a control module 12 and a plurality of luminescent elements 14. The recognition module 10 serves to recognize outputted contents (i.e. a first character inputted by the user) shown on a display 3 (shown in FIG. 3), which is electrically connected to the control panel 2, such that a control signal f is generated and transmitted to the control module 12. In response to the control signal f, the control module 12 can activate light emission of at least one of the luminescent elements 14 located under a key marked with an possible phonetic alphabet on the control panel while inhibit light emission of luminescent elements corresponding to other keys, such that the position of each key marked with the possible phonetic alphabet is highlighted for the user to rapidly select the phonetic alphabet required to be inputted. Therefore, time consumption required for searching the positions of the keys can be shortened to improve user's input speed of Chinese characters.

FIG. 3 is a schematic diagram showing an appearance of a cellular phone which employs the present invention. Referring to the figure, the control panel 2 installed in a cellular phone 4 can be an interface which permits input of Chinese characters using input methods such as the Chinese phonetic alphabet, Pinyin or Chinese character strokes. The Chinese phonetic alphabet input method is illustrated in the present invention. The control panel 2 further comprises a keyboard 22 and a control button 23. Moreover, the keyboard 22 further comprises a plurality of keys 220 which are “1 [symbol] (referred to as key 1), “2 [symbol] (referred to as key 2), “3 [symbol] (referred to as key 3), “4 [symbol] (referred to as key 4), “5 [symbol] (referred to as key 5), “6 [symbol] (referred to as key 6), “7 [symbol] (referred to as key 7), “8 [symbol] (referred to as key 8), “9 [symbol] (referred to as key 9), [symbol] (referred to as key * ), “0 [symbol] (referred to as key 0) and “# [symbol] (referred to as key #). In order to provide a brief description for the present invention, the phonetic alphabets [symbol] [symbol] [symbol] [symbol] marked on the plurality of keys 220 in the keyboard 22 are defined as a first category of phonetic alphabets, the phonetic alphabets [symbol] as a second category of phonetic alphabets and the phonetic alphabets [symbol] [symbol] [symbol] as a third category of phonetic alphabets. What needs to be specifically illustrated here is that the structure of the control panel 2 and the number and arrangement of the keys contained in the control panel 2 can be modified based on different views and applications. Therefore, the embodiment shown in FIG. 2 only serves as a demonstrative example for the present invention with no intention to limit the invention.

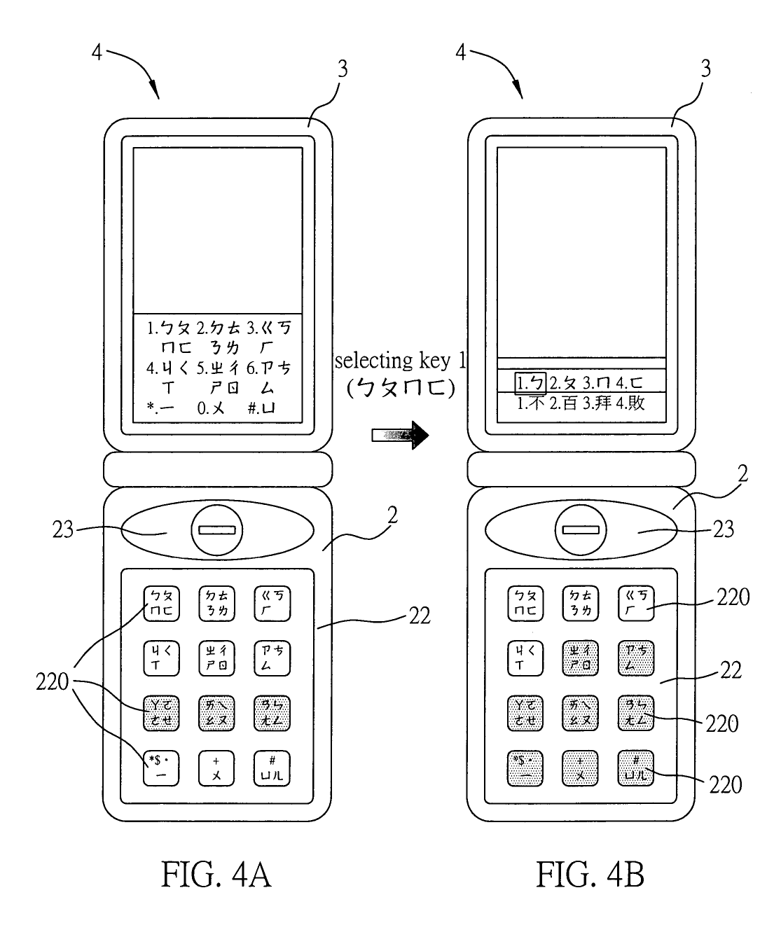

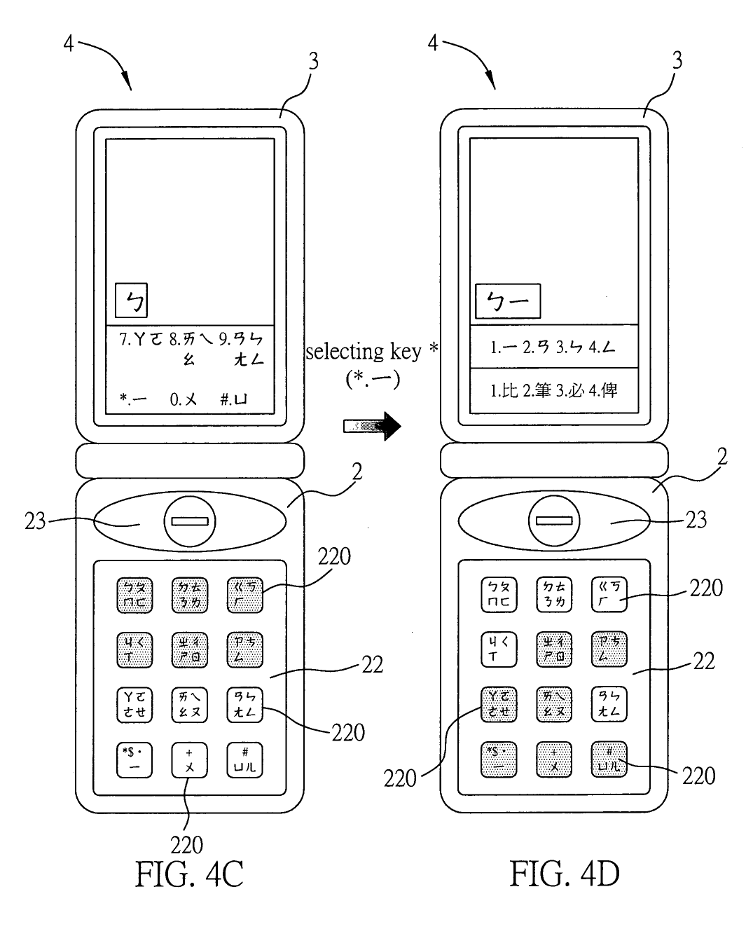

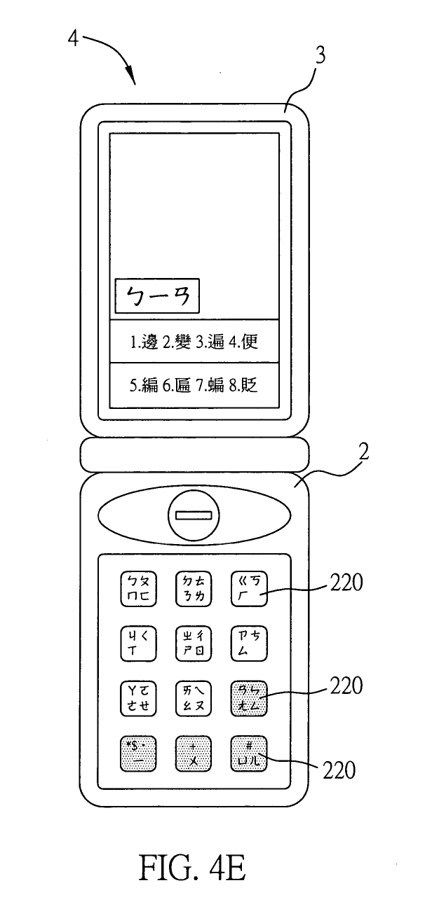

In order to further illustrate advantages and effects of the present invention, steps of inputting a Chinese word [symbol] (shown as [symbol] by the phonetic alphabets) via the control panel 2 and outputting such Chinese character on the display 3 using the auxiliary input method proposed in the present invention are described. Referring to FIG. 4A, after input operation has started, the display 3 electrically connected to the control panel 2 serves to display the first category of phonetic alphabets and the second category of phonetic alphabets corresponding to respective keys (i.e. 1) [symbol] 2 [symbol] 3 [symbol] 4 [symbol] 5 [symbol] 6 [symbol] 7 [symbol] 8 [symbol] 9 [symbol] 0 [symbol] and # [symbol] Then, the auxiliary input device 1 serves to recognize that the first and second categories of phonetic alphabets are shown on the display 3, and activates light emission of the luminescent element 14 corresponding to the key 220 marked with the first and second categories of phonetic alphabets (i.e. key 1 to key 6, key *, key 0 and key #) on the keyboard 22 of the control panel 2, such that the user is able to rapidly select the required key to input the required Chinese character.

Referring to FIG. 4B, the user selects the key 220 marked with [symbol] (i.e. key 1: “1 [symbol] in response to this, the display 3 is updated to output the newest content (i.e. 1 [symbol] 2 [symbol] 3 [symbol] 4 [symbol] and 1 [symbol] 2 [symbol] 3 [symbol] 4 [symbol] Then, the auxiliary input device 1 serves to recognize the content outputted on the display 3, and activates light emission of the luminescent elements 14 for those keys 220 that correspond to the available selection numbers on the display (i.e. keys 1 to 4 are highlighted as four selections are available). Then the user selects the key 1 from the illuminated keys, thereupon, the phonetic alphabet [symbol] is shown on the display 3 (shown in FIG. 4). Furthermore, the control button 23 on the control panel 2 can be used to perform selection for inputting the first category of phonetic alphabet

[symbol]

Referring to FIG. 4C, the display 3 is updated and outputs contents of keys marked with the second and third categories of phonetic alphabets (i.e. 7. Y [symbol] 8. [symbol] 9. [symbol] [symbol] 0. [symbol] and [symbol] These phonetic alphabets are candidate characters that may follow the previously selected phonetic alphabet [symbol] to create a pronunciation of a word. Then, the auxiliary input device 1 is able to recognize the content outputted on the display 3, and similarly, activates light emission of the luminescent elements 14 for those keys 220 on the keyboard 22 that correspond to the displayed content (i.e. key 7 to key 9, key *, key 0 and key # marked with the possible second and third categories of phonetic alphabets that can follow the phonetic alphabet [symbol] of the first category to form a pronunciation of a word).

Referring to FIG. 4D, the user selects key * (i.e. [symbol] ) among the illuminated keys 220. As a result, the display 3 is updated to display the newest content (i.e. 1. [symbol] 2. [symbol] 3. [symbol] 4. [symbol] and 1. [symbol] 2. [symbol] 3. [symbol] 4. [symbol] The auxiliary input device 3 then recognizes the content outputted on the display 3, and similarly, activates light emission of the luminescent elements 14 for those keys 220 that correspond to the available selections shown on the display 3. That is, keys 1 to 4 are highlighted to indicate the available four selections. Note that key 9 is also highlighted since those possible phonetic alphabets following the entered alphabets [symbol] are marked thereon.

Referring to FIG. 4E, the user selects phonetic alphabet [symbol] of the third category by pressing the highlighted key 2 or key 9 or by navigating using the control button 23. Subsequently, a confirmation button of the control button 23 is pressed to confirm the completion of the input. Meanwhile, the display 3 is updated to output the newest content (i.e. a string of the inputted phonetic alphabets [symbol] and possible Chinese words that all pronounce like [symbol] ). Furthermore, the auxiliary input device 1 serves to recognize the outputted content on the display 3, so as to illuminate the keys 220 related to the outputted content (i.e. key 1 to key 8) on the keyboard 22, such that the user is able to make the desired selection (key 2) in order to complete the input of the Chinese character [symbol] using the illuminated keys as a guide.

The Chinese character auxiliary input method illustrated in the present invention uses an auxiliary input device to recognize phonetic alphabets inputted via a control panel by a user, and to illuminate key(s) on the control panel being marked with selections of candidate phonetic alphabets that can follow the previous inputted alphabets. Thus, the user is able to rapidly select a required key to input the phonetic alphabet and output the phonetic alphabet on a display. Therefore, in comparison to the conventional technique, the present invention is capable of shortening time spent for searching the positions of characters on the control panel, so as to improve the input efficiency of Chinese characters.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A Chinese character auxiliary input method applicable to an electronic equipment for reducing time consumed for searching a position of a key by a user, the method comprising steps of:
(1) recognizing a first character inputted by the user and shown on a display of the electronic equipment, such that a control signal is generated according to the recognized result;
(2) selecting at least one key marked with a second candidate character that may possibly follow the first character according to the control signal, and sending out an actuation signal; and
(3) actuating light emission of at least one luminescent element to indicate the positions of the key according to the actuation signal.

2. The Chinese character auxiliary input method of claim 1, wherein, when inputting a Chinese word, a step of repeating the foregoing step (1) to step (3) is performed until input operation of at least a Chinese word has been completed.

3. The Chinese character auxiliary input method of claim 1, wherein the electronic equipment is selected from the group consisting of a cellular phone, a personal computer, a notebook computer, an electronic translator and a personal digital assistance.

4. The Chinese character auxiliary input method of claim 1, wherein the Chinese character is inputted via an input method selected from the group consisting of Chinese phonetic alphabet, Chinese character stroke and Pinyin.

5. A Chinese character auxiliary input device applicable to an electronic equipment for indicating a position of a key required to be inputted by a user, the device comprising:
a recognition module for recognizing a first character inputted by the user and shown on a display of the electronic equipment, such that a control signal is generated according to the recognized result;
a control module for selecting at least one key marked with a second candidate character that may possibly follow the first character according to the control signal, and sending out an actuation signal; and
a plurality of luminescent elements corresponding to the number of the keys for generating light emission to indicate the positions of the keys according to the actuation signal transmitted by the control module.

6. The Chinese character auxiliary input device of claim 5, wherein the electronic equipment is selected from the group consisting of a cellular phone, a personal computer, a notebook computer, an electronic translator and a personal digital assistance.

7. The Chinese character auxiliary input device of claim 5, wherein the Chinese character is inputted via an input method selected from the group consisting of Chinese phonetic alphabet, Chinese character stroke and Pinyin.

8. The Chinese character auxiliary input device of claim 5, wherein the candidate characters refers to those characters that may be combined with the first character to form a pronunciation of a word.
